(19) United States
(12) Patent Application Publication
(10) Pub. No.: US 2010/0302654 A1
(43) Pub. Date: Dec. 2, 2010

(54) FRESNEL LENS

(76) Inventors: Takashi Amano, Hodogaya-ku (JP); Tsunehisa Nakamura, Tokyo (JP); Hiroyuki Kobayashi, Tsukuigun (JP)

Correspondence Address: 3M INNOVATIVE PROPERTIES COMPANY, PO BOX 33427, ST. PAUL, MN, 55133-3427, US

(21) Appl. No.: 12/517,219

(22) PCT Filed: Nov. 19, 2007
(86) PCT No.: PCT/US07/85041

§ 371 Date: Jul. 13, 2010

(30) Foreign Application Priority Data
Dec. 6, 2006 (JP) 2006 329472

(51) Int. Cl. G02B 3/08

(52) U.S. Cl. 359/742

(57) ABSTRACT

To provide a Fresnel lens wherein changes in focal length due to temperature dependence of the refractive index can be compensated. By introducing a fractal structure into prisms in a peripheral region in which the prism angle is large and therefore the aspect ratio h/p of the prisms is large, the aspect ratio is reduced from h/p to h′/p and the slope of the envelope 20 to the underside of the slopping face is reduced, and thereby a shape in which a change in focal length due to temperature dependence of refractive index can be compensated for by a change in the shape of lenses due to expansion/contraction, is obtained.

### TECHNICAL FIELD

The present invention relates to a Fresnel lens.

### BACKGROUND

A Fresnel lens is a lightweight and compact flat lens constructed by replacing the curved surface of a convex lens or a concave lens with a series of discontinuous curved surfaces formed by a plurality of prisms arranged concentrically or in parallel, thereby reducing the lens thickness to the minimum required to achieve the necessary curved surface.

Fresnel lenses are widely used, for example, to convert light from a point light source into parallel light, as exemplified by a lens used in a backlight system of a rear-projection liquid crystal display, or conversely to concentrate parallel light into a defined beam, as exemplified by a light-gathering lens used in a solar power generating system.

Plastic resins such as acrylics and polycarbonates are widely used as materials for Fresnel lenses; among others, for outdoor applications, silicones (silicone rubber, silicone resin, etc.) are promising materials because of their excellent heat resistance, weather resistance, and reliability. Silicones excel over other optical materials such as polycarbonates in transmittance in the short-wavelength region of 250 nm to 350 nm, and are particularly promising materials for applications in electric-power generating systems in which multi junction semiconductors that utilize light in a wide wavelength range from short to long wavelengths are used as cells.

However, since the temperature dependence of the refractive index of silicone materials is generally larger than that of other materials such as acrylic and polycarbonate resins, there has been the problem that the focal length changes with ambient temperature, causing the power generation efficiency to drop. In particular, the problem has been that the change in the focal length is appreciable in the peripheral region of the lens where the angle of incident light deflection (deviation angle) is large.

### SUMMARY

Accordingly, it is an object of the present invention to provide a Fresnel lens wherein the change in focal length due to a change in temperature can be suppressed even when a material such as silicone, the temperature dependence of whose refractive index is large, is used.

According to the present invention, there is provided a Fresnel lens comprising: a Fresnel lens body having a plurality of prisms; and a flat, transparent supporting member for rigidly supporting the Fresnel lens body, wherein at least some of the plurality of prisms each have a plurality of refracting faces on a sloping face thereof, an envelope tangent to an underside of the sloping face having the plurality of refracting faces is sloped, and the slope of any one of the plurality of refracting faces is greater than the slope of the envelope.

The refracting faces of the prisms forming the Fresnel lens are sloped greater as the prisms are located farther away from the optical axis; here, when the prisms in the region where their slopes must be made greater are formed as described above, the angle of slope of the envelope tangent to the underside of the sloping face can be reduced while leaving the angle of slope of each refracting face unchanged, and with this structure, the change in refractive index caused by a change in temperature can be properly compensated for by a change in shape occurring due to the thermal expansion/contraction of the Fresnel lens body rigidly supported on the supporting member.

For example, at least some prisms each have a shape produced by integrally forming a first prism having a first sloping face and a plurality of second prisms each having a second sloping face, with the second prisms being formed to cover the first sloping face and each of the second prisms being oriented so that the slope of the second sloping face becomes greater than the slope of the first sloping face, or a shape produced by repeating the integral formation at least once in a recursive manner by regarding each of the plurality of second prisms as the first prism.

In this way, by introducing a so-called fractal structure, the angle of slope of the envelope tangent to the underside of the sloping face can be reduced while leaving the angle of slope of each refracting face unchanged.

It is therefore desirable that the slope of the envelope be designed so that a change in refractive index due to a change in temperature can be canceled out by a change in the shape of the Fresnel lens rigidly supported on the supporting member.

The present invention is applicable not only to a circular Fresnel lens in which prisms are arranged in concentric circles, but also to a lens in which prisms are arranged side by side in parallel, and can be applied not only to a lens for obtaining parallel light but also to a light-gathering lens, although the following description specifically deals with an example in which the present invention is applied to a light-gathering circular lens, in particular, a lens for gathering solar light onto a semiconductor cell.

### BRIEF DESCRIPTION OF THE DRAWINGS

FIG. 1 is a cross-sectional view of a circular Fresnel lens.

FIG. 2 is a plan view of the circular Fresnel lens as viewed from the grooved side thereof.

FIG. 3 is a diagram for explaining the focal length of a Fresnel lens.

FIG. 4 is a diagram for explaining how the focal length changes when refractive index changes.

FIG. 5 is a diagram showing the case in which light rays are correctly focused on a cell.

FIG. 6 is a diagram showing the case when temperature rises.

FIG. 7 is a diagram showing the case when temperature lowers.

FIG. 8 is a diagram for explaining the compensating effect due to thermal expansion.

FIG. 9 is a diagram showing the thermally expanded shape of a lens whose bottom face is restrained by an attached glass.

FIG. 10 is a diagram showing the lens shape when contracted.

FIG. 11 is a diagram for explaining the compensating effect in an inner radius region of a lens where the prism vertex angle α is small.

FIG. 12 is a diagram for explaining the compensating effect in an outer radius region of a lens where the prism vertex angle α is large.

FIG. 13 is a diagram showing one example of a prism having a fractal structure according to one aspect of the present invention.

FIG. 14 is a diagram for explaining how the aspect ratio decreases when the fractal structure is introduced.

FIG. 15 is a diagram showing one example of a prism having a three-layer fractal structure.

FIG. 16 is a diagram showing one example of a prism according to one aspect of the present invention in which the envelope contained inside the prism is not a straight line.

FIG. 17 is a diagram showing the shape of the prism used for measurement.

FIG. 18 is a graph showing measurement results in a working example of the present invention.

FIG. 19 is a diagram showing measurement results in a first comparative example.

FIG. 20 is a diagram showing measurement results in a second comparative example.

FIG. 21 is a diagram for explaining measurement conditions.

### DETAILED DESCRIPTION OF PREFERRED EMBODIMENTS

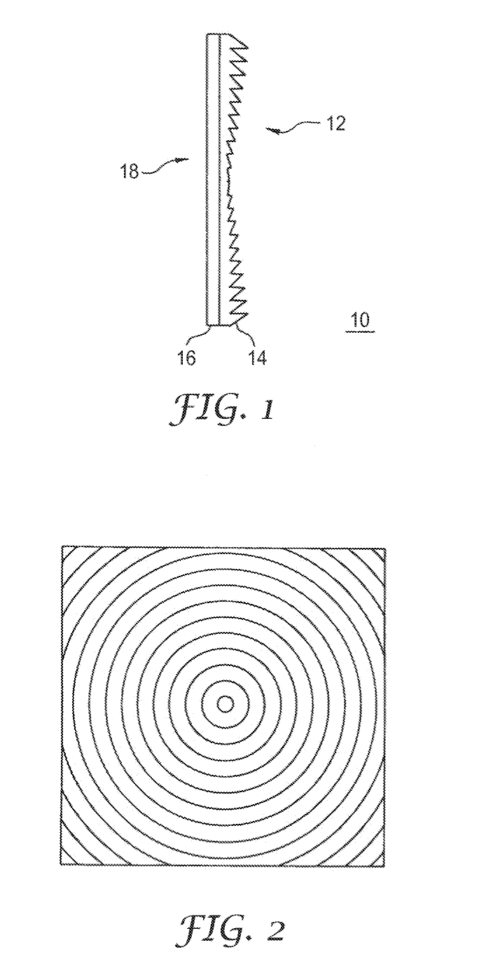

FIG. 1 is a cross-sectional view of a light-gathering circular Fresnel lens 10, and FIG. 2 is a plan view as viewed from the grooved side 12 thereof. As shown in FIG. 1, when a flexible material such as silicone rubber is used as the material for the lens, a glass or other relatively rigid material 16 is attached to the plane side of the Fresnel lens body 14, and light is incident substantially perpendicular to the glass face 18. The shape of the glass is usually square, as shown in FIG. 2, and a plurality of such elements may be combined to form an array structure.

The lens has the function of concentrating the solar light incident on the glass face 18 onto a semiconductor cell located at a distance equal to the focal length (f) away from the lens. For electric-power generation efficiency, the lens is designed by considering such factors as the transmittance and chromatic aberration for each wavelength of light and the intensity distribution of gathered light.

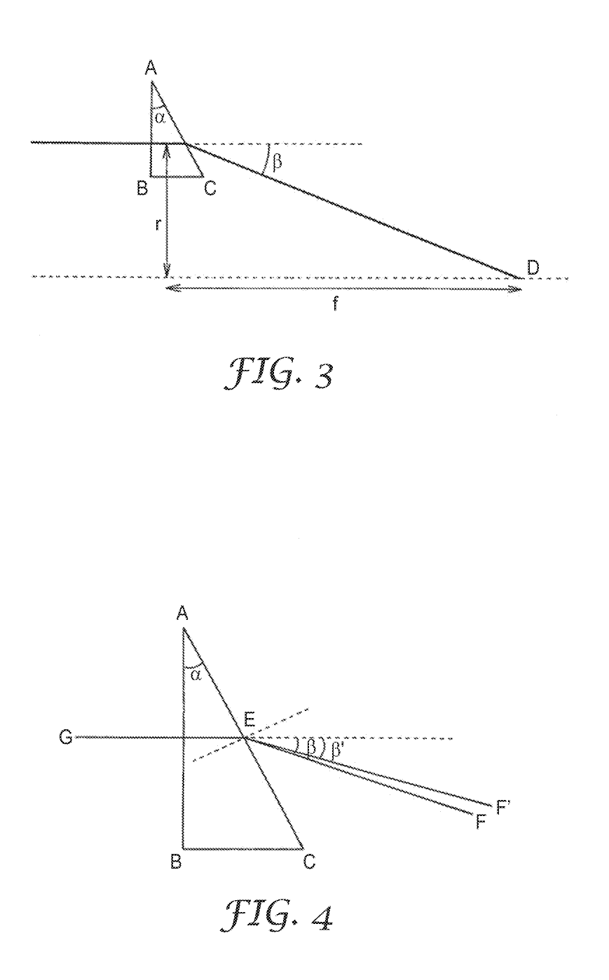

Referring to FIG. 3, a description will be given of the relationship between a prism in a point-focus Fresnel lens and its focal length. The angle BAC=α with respect to the incident light in FIG. 3 is defined as the vertex angle of the prism or the prism angle in the following description. The light entering the prism, which has the prism angle α and is located at a distance equal to the radius (r) away from the optical axis, is refracted at the sloping face AC in accordance with Snell's law, is bent at the deviation angle β, and intersects the optical axis at point D; the distance to the point D is the focal length f which is given as:

$$f = \frac{r}{tan ( {sin}^{- 1} ( n sin α ) - α )}$$

where n is the refractive index of the prism.

The deviation angle is given by:

β=sin⁻¹(n sin α)−α

In the actual outdoor environment where solar power generation is performed, the temperature changes widely, and the concentrator and the lens material are subjected to severe temperature changes.

If the refractive index of the prism having the vertex angle α decreases as the temperature rises, the light ray changes from GEF to GEF′ as shown in FIG. 4. The deviation angle β changes to β′. The deviation angle difference Δβ is:

Δβ=sin⁻¹(n sin α)−sin⁻¹(n′ sin α)

and the light ray intersects the optical axis at a point displaced, as seen from the center of the lens, in the direction away from the optical axis by a distance given by:

Δ=f·(tan β−tan(β−Δβ))

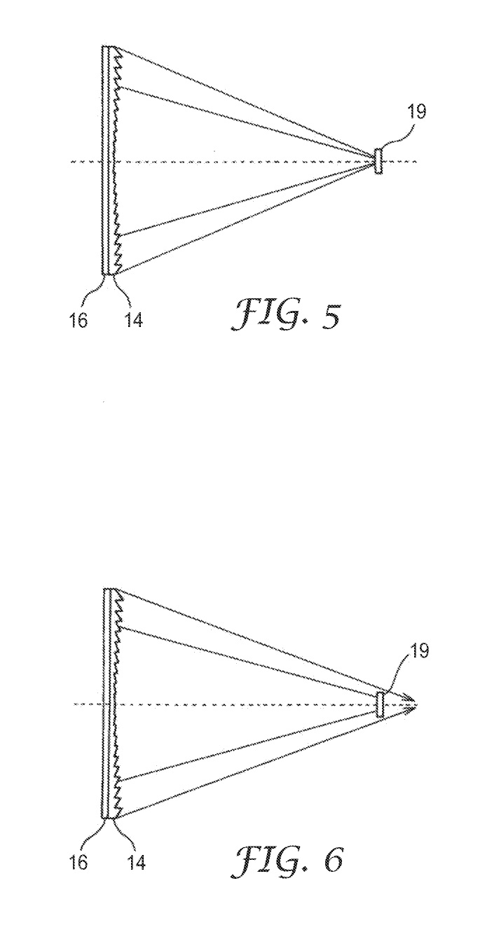

That is, in the summertime when the temperature generally rises, the refractive index of the lens, which has a temperature dependence, decreases in accordance with the temperature dependence, dn/dT, of the refractive index of the lens material, and the focal length increases from the condition shown in FIG. 5 to the condition shown in FIG. 6. The change in the refractive index becomes greater as the distance from the center of the lens 14 increases; as a result, the light passing through the peripheral region of the lens 14 does not fall on the cell 19 but is focused somewhere beyond the cell 19, and thus the amount of light falling on the cell decreases.

Conversely, in the wintertime when the temperature decreases, the refractive index increases, and the focal length becomes shorter; in this case also, the change in the refractive index is greater in the peripheral region of the lens 14, and as a result, the light passing through the peripheral region of the lens 14 is focused somewhere away from the cell 19, as shown in FIG. 7. The prisms located in the peripheral region of the lens have a larger vertex angle α than those in the inside region, and the angle of the sloping face that causes refraction (the refracting face) becomes steeper. As a result, if the refractive index changes only slightly in accordance with Snell's law, its effect manifests itself in an exaggerated form, presumably because of the nonlinear relationship between the vertex angle α and the deviation angle β.

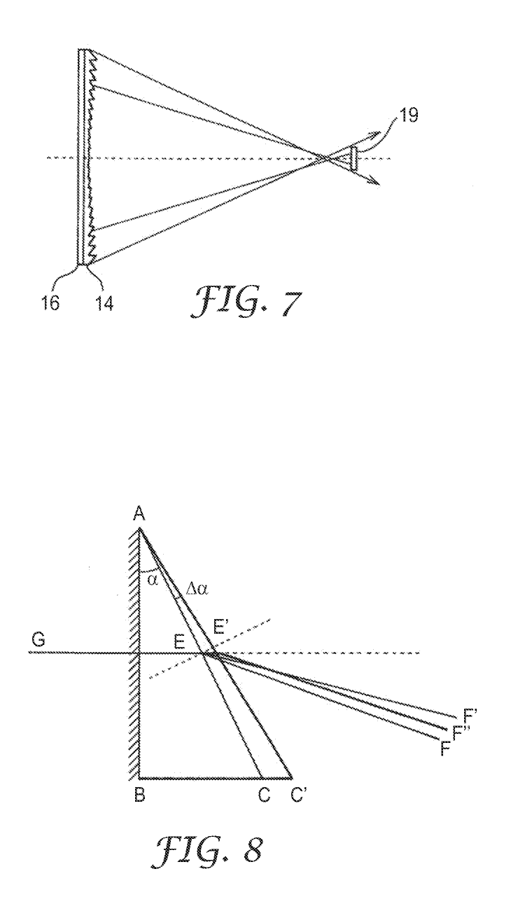

On the other hand, the light incident side of the lens 14 is restrained by the rigid base 16 to which it is attached. As a result, as the temperature rises, the volume of the prism expands in accordance with its thermal expansion coefficient, and the prism shape changes from the rectangle ABC to the rectangle ΔABC′ as shown in FIG. 8, increasing the prism angle α by Δα. The light ray for which the focal length has increased from GEF to GEF′ due to the decreased refractive index is now refracted at point E′, and emerges as a light ray GE′F″; in this way, it is expected that a compensating effect works that brings the focal length closer to that of the original light ray GEF.

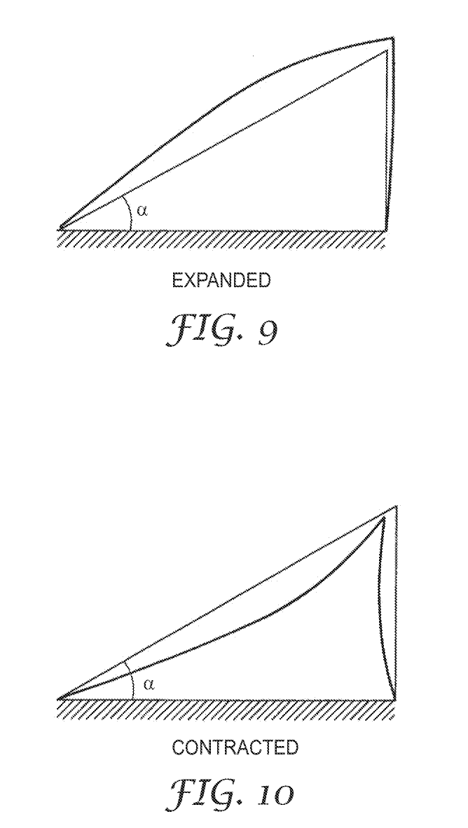

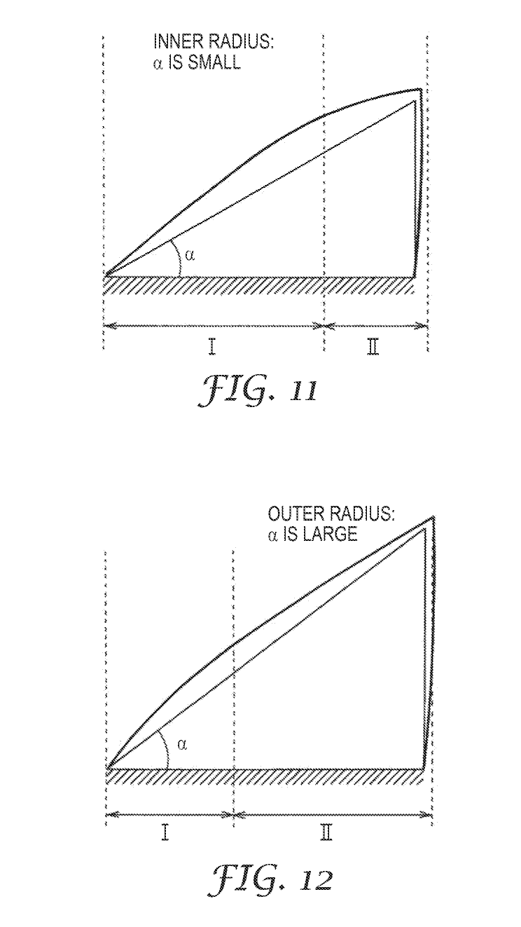

The bottom surface of the Fresnel lens is attached to the surface of the base, and is thus restrained by the base. Accordingly, noting one prism in the cross-sectional view, it is seen that its bottom line is restrained. Through a computer analysis of thermal stress, it is known that when the temperature rises, the prisms are deformed as shown in FIG. 9. Conversely, it is known that when the temperature lowers, the prism contracts as shown in FIG. 10.

In FIG. 11, when the temperature rises, causing the prism to expand, the slope of the refracting face in Region I becomes steeper to compensate for the change in focal length, while the slope of the refracting face in Region II becomes gentler and no compensation is done in this region. Larger ratios of Region I to Region II are preferred. As shown in FIG. 12, in the case of a prism located in the peripheral region of the lens and thus having a large vertex angle α, the ratio of Region I at the time of expansion decreases, and the temperature compensating effect for the focal length drops appreciably, compared with a prism having a smaller vertex angle α. The reason for this is that since the aspect ratio of the prism (the ratio of the height h to the pitch p: h/p) is large, the prism tends to expand greater in the direction normal to the height direction than in the height direction.

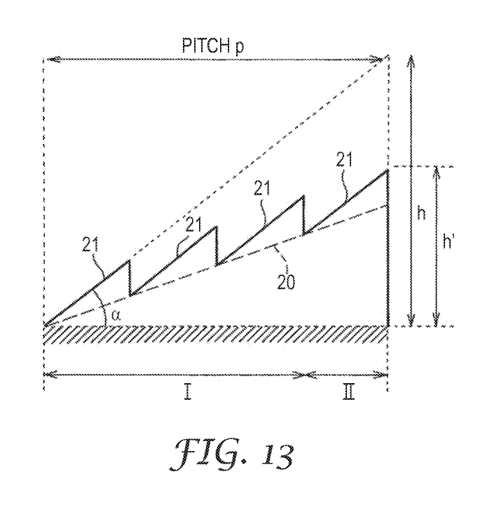

By introducing a fractal structure for the construction of prisms in the peripheral region where the aspect ratio is large, as shown in FIG. 13, the aspect ratio as a whole can be reduced while maintaining substantially the same optical function. In other words, by reducing the slope of the envelope 20 that is tangential to the underside of the sloping face having a plurality of refracting faces 21, the temperature compensating effect can be increased.

When the slope of the envelope 20 is thus reduced, the ratio of Region I to Region II at the time of thermal expansion increases, increasing the temperature compensating effect for the focal length.

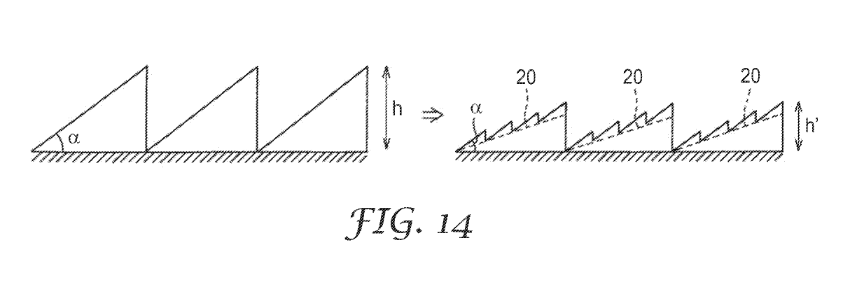

As shown in FIG. 14, when such a fractal structure is introduced, the combined height, h, of three prisms having the same vertex angle α, deviation angle, and pitch is reduced to h′, and the angle of slope of the envelope 20 tangent to the underside of the sloping face becomes smaller than the prism angle α.

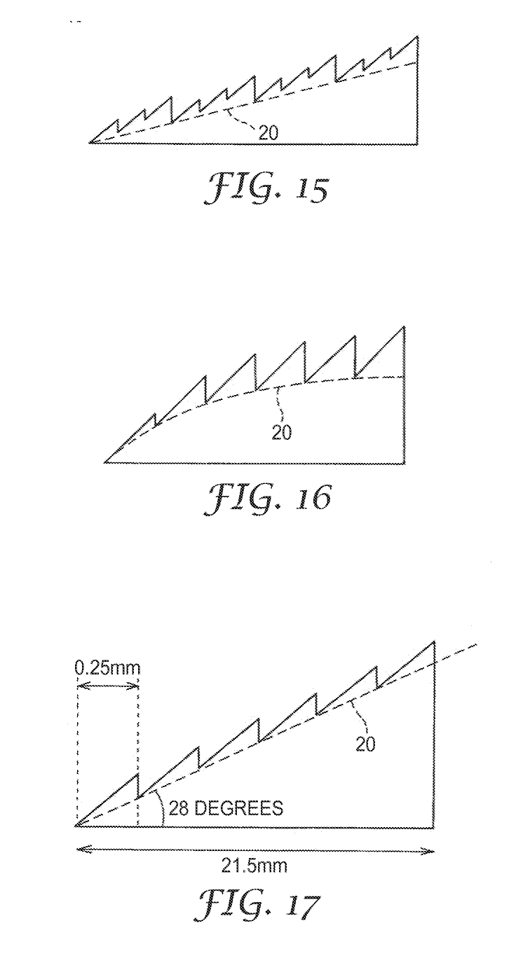

FIG. 15 shows an example of a prism having a three-layer fractal structure. It will be recognized here that the sloping line of the envelope 20 need not necessarily be a straight line, and that a Fresnel lens using a prism such that the sloping line of the envelope 20 is a curved line, as shown for example in FIG. 16, also falls within the scope of the present invention. That is, in the present invention, the change in refractive index is compensated for by designing the slope of the envelope tangent to the underside of the sloping face so that the change in refractive index due to a change in temperature is canceled out by the change in the shape of the prism itself, while keeping the sloping angle α of the refracting face unchanged.

Various resins, such as silicone, PMMA, and polycarbonate, that are transparent at the operating wavelength are used as lens materials. Among others, silicone resin and silicone rubber are preferred because of their good environmental resistance. Silicone rubber can be used most advantageously because of its high transmittance, UV resistance, thermal resistance, humidity resistance, and other considerations.

High flatness, small thermal expansion, and high transparency at the operating wavelength are the properties required of the base material. Specifically, a quartz plate, a glass plate, and a resin plate of PMMA, polycarbonate, or the like can be used advantageously.

When the sign of the temperature dependence (dn/dT) of the refractive index of the lens material is negative, the thermal expansion coefficient (coefficient of linear expansion) of the lens material should be larger than that of the base material.

Preferably, the difference in thermal expansion between the base material and the lens material is relatively large. This allows the lens to deform easily in the vertical direction, achieving a greater temperature compensating effect.

The optimum slope angle of the envelope is dependent on such factors as the angle of the refracting face of the prism, the temperature dependence of the refractive index of the prism material, the thermal expansion coefficients of the prism material and the base material, the difference in thermal expansion between them, and the range of ambient temperature variation.

Generally, it is preferable that the angle of slope of the envelope be set not greater than about 35 degrees. If the angle is greater than about 35 degrees, the temperature compensating effect will decrease. More preferably, the angle is set not greater than about 30 degrees. Preferably, the angle is about 5 degrees or more. If the angle is too small, the lens structure will become substantially the same as the lens structure that does not have a fractal structure, and the temperature compensating effect according to the present invention cannot be obtained. More preferably, the angle is about 10 degrees or more.

The diagrams so far given have shown the structure in which the prisms are attached directly to the base plate, but it will be recognized that a layer of uniform thickness formed from the same material as the prisms may be interposed between the base plate and the prisms.

### EXAMPLES

### Example 1

A circular point-focus Fresnel lens having a focal length of 360 mm and a diameter of 340 mm was fabricated. In the region within a radius of 82 mm, one prism was formed within one pitch as in the conventional Fresnel lens. In the region outside the 82-mm radius, sub-prisms were formed at a pitch of 0.25 mm on a prism having a pitch of 1.5 mm and a prism angle of 28 degrees, as shown in FIG. 17, that is, the structure of the prism was such that the angle of slope of the envelope tangent to the underside of the sloping face having refracting faces formed by the plurality of sub-prisms was 28 degrees. Six sub-prisms were formed on one prism. The sub-prisms were designed by varying their slope angles in the radial direction so that the light rays passing therethrough were brought to a focus at a focal distance of 360 mm.

A mold was produced by cutting an acrylic plate with a diamond bite, and a commercially available room-temperature curing silicone rubber was applied thereon and formed to fabricate a lens on a glass plate 3 mm thick and 240 mm square.

### Comparative Example 1

A conventional Fresnel lens was designed so that the lens groove depth was uniform at 0.7 mm in the radial direction. The prism angle α of the outermost prism was about 40 degrees, the prism pitch was 0.9 mm, and the height was 0.7 mm. The lens was fabricated by the same process as the working example.

### Comparative Example 2

A conventional Fresnel lens was designed so that the lens groove depth was tapered in the radial direction, the groove depth being 0.7 mm in the peripheral region and 0.5 mm in the center region. The prism angle α of the outermost prism was about 40 degrees, the prism pitch was 0.9 mm, and the height was 0.7 mm. The lens was fabricated by the same process as the working example.

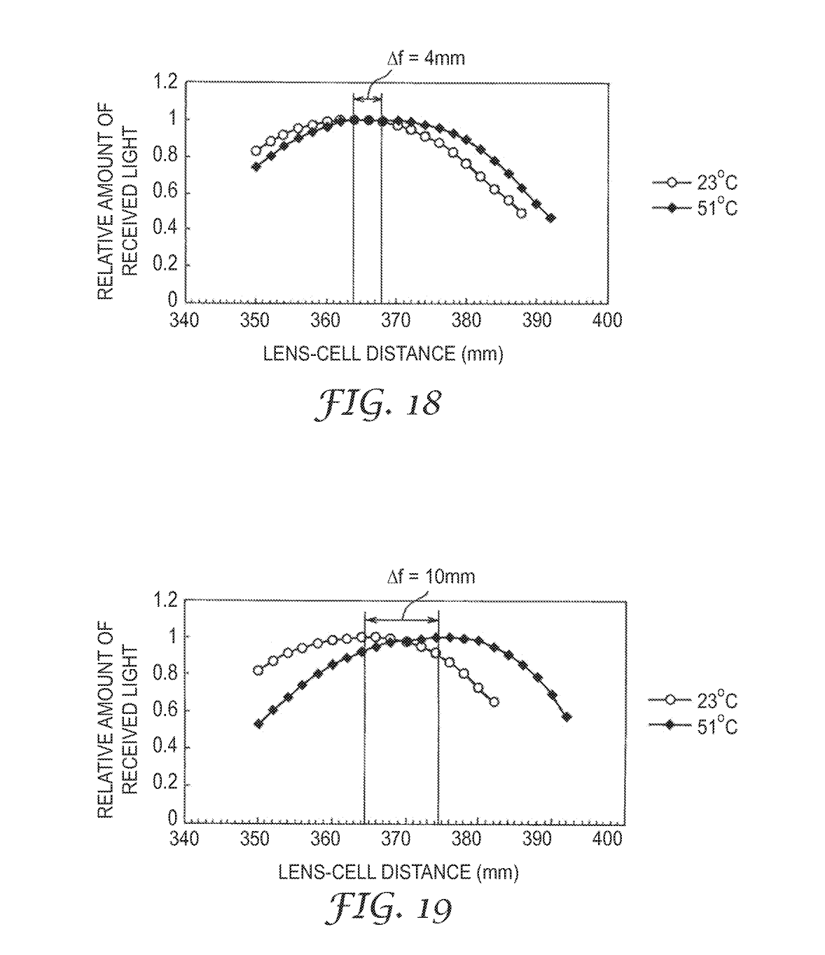

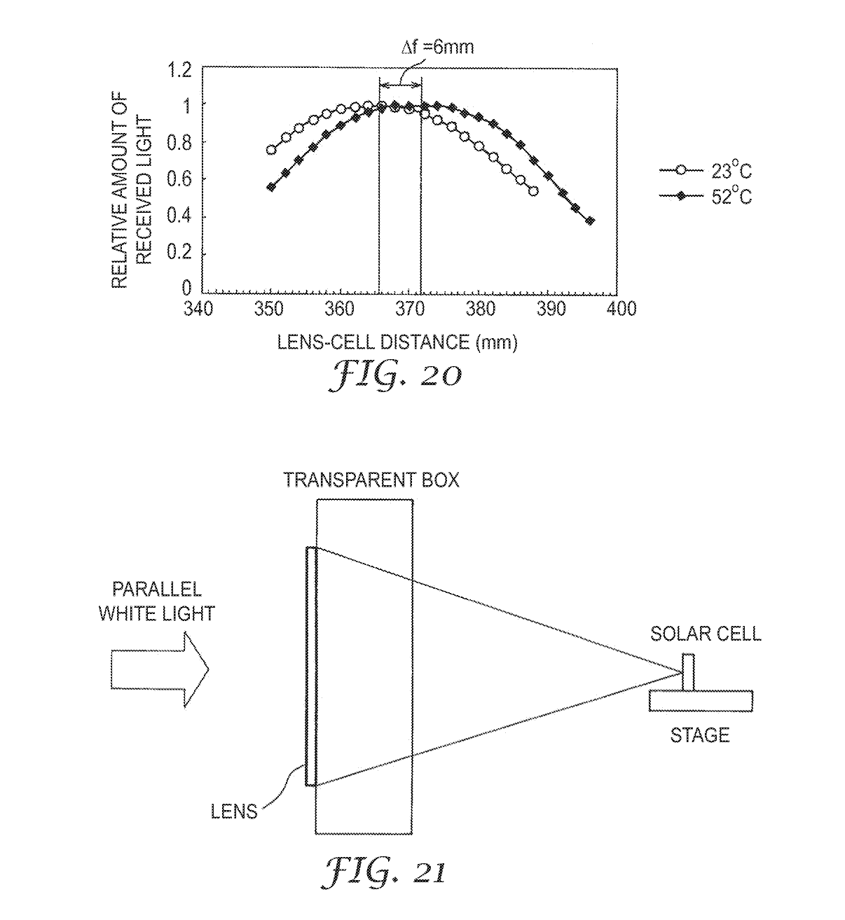

FIGS. 18, 19, and 20 show the results of the measurements of the relative amount of received light as a function of lens-cell distance at different temperatures for the working example, the first comparative example, and the second comparative example, respectively; it is shown how differently the focal length changes with temperature. In these figures, the lens-cell distance at which the relative amount of received light is the largest corresponds to the focal length of the lens.

In making the measurements, the relationship between the lens and the concentrator structure was considered, and the inside of the lens was heated by hot air as shown in FIG. 21; then, a single-crystal silicon solar cell was placed on a stage, and the relative amount of light was computed by measuring the voltage while varying the distance along the direction of focus.

For a temperature change of 30 degrees, the change Δf in the focal length of the Fresnel lens of the working example was 4 mm, whereas the change was 10 mm and 6 mm in the first and second comparative examples, respectively, and it was thus found that, in the Fresnel lens of the present invention, the change Δf in focal length due to a temperature rise was small, achieving an excellent temperature compensating effect.

What is claimed is:

1. A Fresnel lens comprising a Fresnel lens body having a plurality of prisms and a flat, transparent supporting member for supporting said Fresnel lens body; wherein
at least one of said plurality of prisms has a plurality of refracting faces on a sloping face thereof; wherein an envelope tangent to an underside of said sloping face having said plurality of refracting faces is sloped; and wherein the slope of any one of said plurality of refracting faces is greater than the slope of said envelope.

2. A Fresnel lens according to claim 1, wherein said at least one prism has a shape produced by integrally forming a first prism having a first sloping face and a plurality of second prisms each having a second sloping face, with said second prisms being formed to cover said first sloping face, each of said second prisms being oriented so that the slope of said second sloping face becomes greater than the slope of said first sloping face, or a shape produced by repeating said integral formation at least once in a recursive manner by regarding each of said plurality of second prisms as the first prism.

3. A Fresnel lens according to claim 1 or 2, wherein the slope of the envelope is designed so that a change in refractive index due to a change in temperature can be canceled out by a change in the shape of said Fresnel lens supported on the supporting member.

4. A Fresnel lens according to claim 3, wherein the angle of slope of the envelope is not less than about 5 degrees but not greater than about 35 degrees.

5. A Fresnel lens according to any one of claims 1 to 4, wherein the thermal expansion coefficient of said supporting member is less than the thermal expansion coefficient of the Fresnel lens body.

6. A Fresnel lens according to any one of claims 1 to 5, wherein said supporting member is formed from a glass plate, and said Fresnel lens body is formed from a silicone rubber or a silicone resin.
